(19) United States
(12) Patent Application Publication
(10) Pub. No.: US 2005/0257973 A1
(43) Pub. Date: Nov. 24, 2005

(54) Multifunction lever and control unit for an industrial truck

(75) Inventors: Marek Szymanski, Kleinmeisdorf Gemeinde Bosdorf (DE); Roland Tiedemann, Grosshansdorf (DE)

Correspondence Address: THE WEBB LAW FIRM, P.C., 700 KOPPERS BUILDING, 436 SEVENTH AVENUE, PITTSBURGH, PA, 15219, US

(73) Assignee: STILL GmbH, Hamburg (DE)

(21) Appl. No.: 10/947,077

(22) Filed: Sep. 22, 2004

(30) Foreign Application Priority Data
Sep. 23, 2003 (DE) 103 44 029.1

(51) Int. Cl. B60R 16/04

(52) U.S. Cl. 180/68.5

(57) ABSTRACT

A multifunction lever for an industrial truck has a handle element (12) mounted so that it can move on a base body (10), and a sensor (20) to detect and measure the movements of the handle element (12) relative to the base body (10). The handle element (12) can be moved relative to the base body (10) in rotation around at least two coordinate axes and in translation in the direction of at least one coordinate axis. The coordinate axes belong to a system of rectangular coordinates.

### CROSS REFERENCE TO RELATED APPLICATION

This application claims priority to German Application No. 103 44 029.1 filed Sep. 23, 2003, which is herein incorporated by reference in its entirety.

### BACKGROUND OF THE INVENTION

1. Field of the Invention

This invention relates to a multifunction lever for an industrial truck, wherein the multifunction lever has a handle element movably mounted on a base body, as well as a sensor to detect and measure the movements of the handle element relative to the base body. The invention likewise relates to a control unit for an industrial truck, wherein the control unit has a multifunction lever with a first handle element movably mounted on a base body.

2. Technical Considerations

Conventionally, either a plurality of individual levers or one multifunction lever are provided for actuation of the numerous functions of an industrial truck by the operator. Multifunction levers generally have a handle that can be tilted around a transverse axis and around a longitudinal axis of the industrial truck. Additional switches that can be actuated with the fingers can also be located on the hand grip. The functions that can be controlled with a multifunction lever are generally the vertical movement of the load-carrying means, the tilting of the load-carrying means, and the lateral displacement of the load-carrying means. With many multifunction levers, it is also possible to control the direction of travel of the industrial truck.

Multifunction levers and control units have the disadvantage that the directions of movement of the hand grip of the multifunction lever or of the control elements located on it often are in no clear relationship to the functions of the industrial truck they control. This lack of a clear correspondence between the movements of the handle and the movements they control makes it difficult for inexperienced drivers to operate the industrial truck and increases the possibility that the driver will give the wrong commands.

Therefore, it is an object of the invention to provide a multifunction lever and a control unit with a multifunction lever in which the majority of the functions of the industrial truck can be actuated in a way that correspond to the functions in question.

### SUMMARY OF THE INVENTION

The invention teaches that the above object can be accomplished by a multifunction lever in which the handle element can be moved in rotation and around at least two coordinate axes relative to the base body and in translation in the direction of at least one coordinate axis. The handle element can thereby be moved in different directions in rotation and translation. Each rotational movement and each translational movement of the handle element thereby corresponds to a defined function of the industrial truck. The sensor that is installed in the multifunction lever detects the movement of the handle element and generates a corresponding control signal. Basically, it is possible to move the handle simultaneously in more than one direction in translation and/or rotation, so that different functions of the industrial truck can be actuated simultaneously. To guarantee the operational safety of the industrial truck at all times, it is possible by mechanical and/or electronic means to at least partly prevent simultaneous operations of selected operations.

The handle element can advantageously be moved in rotation relative to the base body around three coordinate axes. The handle element can thereby be moved in rotation around a transverse axis of the industrial truck, around a longitudinal axis of the industrial truck, and around a vertical axis.

The handle element can also be moved in translation relative to the base body in at least two coordinate axes, such as in the direction of three coordinate axes. The handle element can then be moved in translation in the direction of a longitudinal axis of the industrial truck, in the direction of a transverse axis of the industrial truck, and in the direction of a vertical axis.

It is thereby advantageous if the coordinate axes belong to a system of rectangular coordinates. In that case, the above-mentioned longitudinal, transverse, and vertical axes are perpendicular to one another.

It is particularly advantageous if the base body is part of an armrest of the industrial truck. The multifunction lever is thereby integrated into an armrest that is located in the vicinity of a driver's seat. The handle element can then be moved by the operator relative to the base body while the operator's arm is supported on the armrest.

It is particularly advantageous if the sensor is configured so that when the handle element is moved in translation in the direction of the vertical coordinate axis, a signal for the vertical movement of load-carrying means is generated. In that case, it is clear that a vertical movement of the load-carrying means can be controlled by a vertical movement of the handle element.

It is likewise advantageous if the sensor is configured so that when there is a movement in translation of the handle element in the direction of the coordinate axis that runs in the transverse direction of the industrial truck, a signal is generated that results in the lateral displacement of the load-carrying means. It is, therefore, likewise clear to an operator that a horizontal movement of the handle element in the transverse direction of the industrial truck will result in a horizontal movement of the load-carrying means, also in the transverse direction of the industrial truck. The horizontal displacement of the load-carrying means relative to a lifting platform is effected by means of a side-loader.

The sensor can further be configured so that in the event of a rotational movement of the handle element around the coordinate axis that runs in the transverse direction of the industrial truck, a signal for the tilting of a load-carrying means is generated. A tilting of the handle element around a transverse axis of the industrial truck therefore results in a tilting of the load-carrying means, likewise around a transverse axis of the industrial truck. Depending on the type of industrial truck, the load-carrying means tip either relative to the lifting platform or together with the lifting platform relative to a frame of the industrial truck.

It is further advantageous if the sensor is configured so that when there is a rotational movement of the handle element around the coordinate axis that runs in the longitudinal direction of the industrial truck, a signal is generated that results in the rotation of a load-carrying means around an axis that is oriented substantially in the longitudinal direction of the industrial truck. A rotation around a longitudinal axis of the industrial truck is possible, for example, with load-carrying means that are configured in the form of bale tongs or barrel tongs.

Additional advantages result if the sensor is configured so that when there is a rotational movement of the handle element around the vertical coordinate axis, a signal is generated that results in the opening or closing of a load-holding device. A load-holding device is provided on certain types of load-holding means, e.g., bale tongs or barrel tongs, for example.

It is particularly advantageous if the sensor is configured so that when there is a translational movement of the handle element in the direction of a coordinate axis that runs in the longitudinal direction of the industrial truck, a signal is generated that determines the direction of travel of the industrial truck. By a translational movement of the handle element in the longitudinal direction of the industrial truck, it is clear that the direction of travel of the industrial truck can be switched back and forth between forward and reverse.

For the control unit, the invention teaches that in addition to the multifunction lever, there can be an additional control lever with a second handle element that can be moved in the longitudinal direction of the industrial truck and which is associated with a signal transmitter for determination of the direction of travel of the industrial truck. The control lever with the second handle element can thereby be actuated independently of the multifunction lever and can be used exclusively to determine the direction of travel of the industrial truck. The second handle element can thereby be movable either in rotation around a transverse axis of the industrial truck or in translation in the longitudinal direction of the industrial truck, to make it clear to the operator that the handle element can be actuated in the direction of the desired direction of travel.

The associations of the functions of the industrial truck with the directions of movement of the handle element are more easily understandable to an operator, particularly on industrial trucks in which the driver's seat is oriented in the longitudinal direction of the industrial truck and the load-carrying means are located in front of the driver's seat. This arrangement is used in particular in counterweighted fork-lift trucks. A correspondingly clear association can also be found on industrial trucks where the driver's seat is oriented in the transverse direction.

Erroneous commands can be largely prevented if the second handle element can be moved exclusively in the longitudinal direction of the industrial truck or exclusively around a transverse axis of the industrial truck.

If the second handle element is located immediately next to the first handle element so that both handle elements can be actuated by an operator without having to change the position of the arm, it is possible to switch back and forth between the first and second handle element particularly quickly, or even to actuate both handles simultaneously.

### BRIEF DESCRIPTION OF THE DRAWINGS

Additional advantages and details of the invention are explained in greater detail below with reference to the exemplary embodiments illustrated in the accompanying schematic figures, in which:

FIG. 1 shows an industrial truck in the form of a fork-lift truck;

FIG. 2 shows a multifunction lever of the invention; and

FIG. 3 shows a control unit of the invention.

### DESCRIPTION OF THE PREFERRED EMBODIMENTS

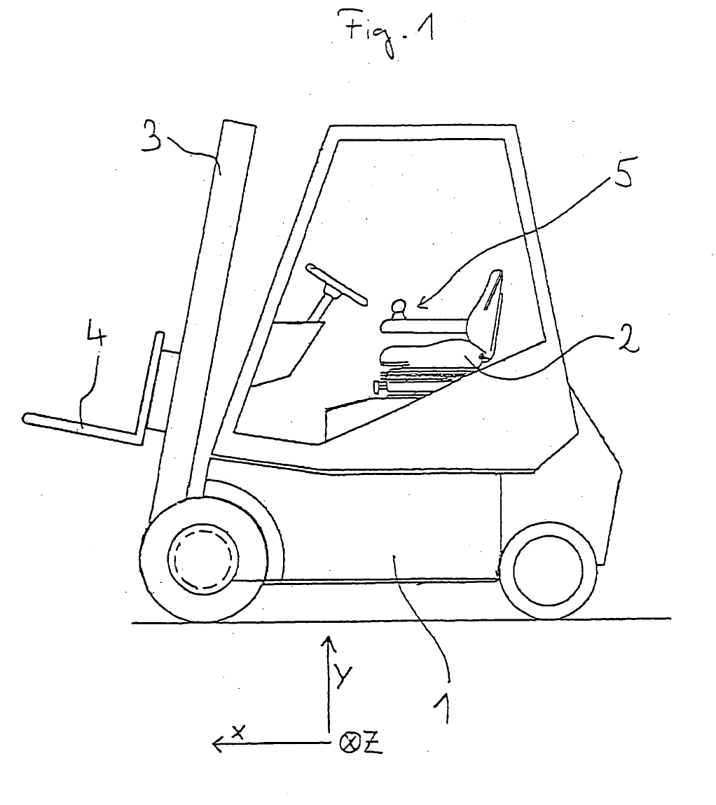

FIG. 1 is a schematic illustration of an industrial truck realized in the form of a fork-lift truck. The illustration shows a vehicle frame 1, a driver's seat 2 that is oriented in the longitudinal direction of the vehicle, a lifting frame 3 that is located in front of the driver's seat 2, and load-carrying means 4 that can be moved vertically along the lifting frame 3. Associated with the driver's seat 2 is a control unit 5 for various functions of the industrial truck, such as for the load-carrying means 4. The directions of movement that are associated with the functions of the industrial truck are described below on the basis of the system of rectangular coordinates shown on the drawings. The coordinate axis x thereby corresponds to the longitudinal direction of the industrial truck, the coordinate axis y to the transverse direction of the industrial truck, and the coordinate axis z to a vertical direction.

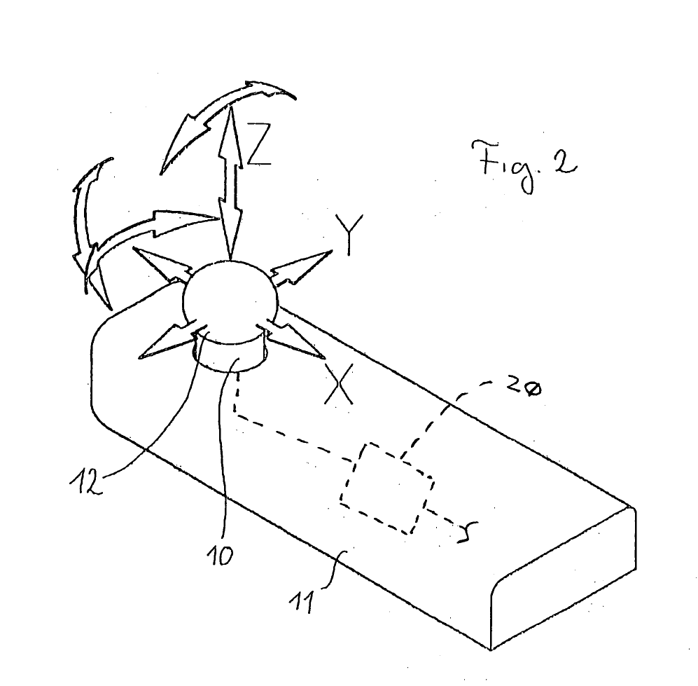

FIG. 2 shows a multifunction lever of the invention. A base body 10 of the multifunction lever is a component of an armrest 11 which is associated with the driver's seat 2. A handle element 12 of the multifunction lever can be moved relative to the base body 10 in the direction of all three coordinate axes x, y and z, and also in rotation around all three coordinate axes x, y and z. The coordinate system of the multifunction lever thereby corresponds at least approximately to the coordinate system of the industrial truck illustrated in FIG. 1. The handle element 12 is operatively connected to a conventional sensor 20 to sense movement of the handle element 12.

The following exemplary functions of the industrial truck can thereby be associated with the different directions of movement of the handle element 12:
Movement of the handle element 12 in the z-direction: raising or lowering of the load-carrying means 4 in the z-direction;
Rotation of the handle element 12 around the y-axis: tilting of the load-carrying means 4 of the lifting platform 3 around the y-axis;
Rotation of the handle element 12 around the x-axis: rotation of a load-carrying means 4, which can be realized in the form of roller tongs, for example, around the x-axis;
Movement of the handle element in the y-direction: movement of the load-carrying means 4 in the y-direction;
Rotation of the handle element 12 around the z-axis: opening or closing of load-carrying means 4 realized in the form of roller tongs, for example; and
Movement of the handle element 12 in the x-direction: determination of the direction of travel of the industrial truck in the forward or reverse direction.

On other types and configurations of industrial trucks, the movements of the handle element 12 can be associated with additional or different functions. The handle element 12 can also be shaped in any appropriate manner, such as from an ergonomic point of view, for example.

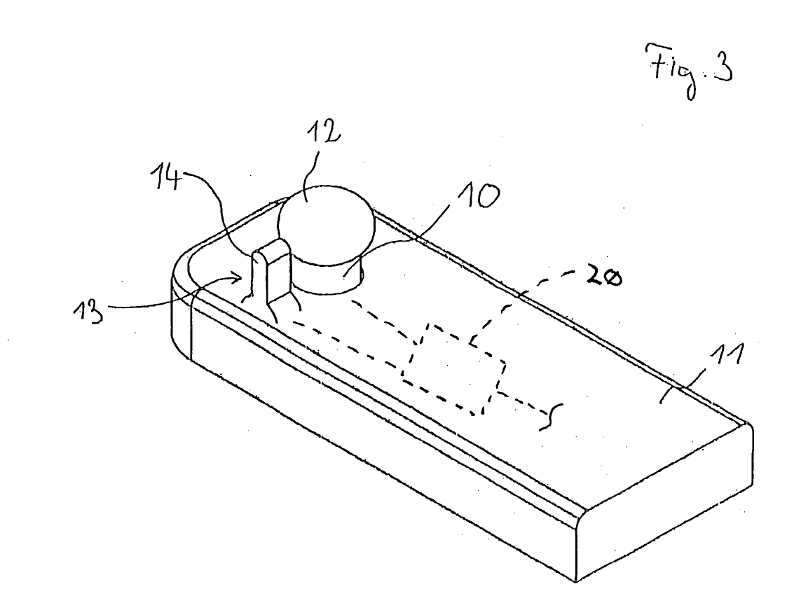

FIG. 3 shows a control unit of the invention with a multifunction lever corresponding to the one illustrated in FIG. 1, and an additional control lever 13 for specifying the direction of travel of the industrial truck. In contrast to the embodiment illustrated in FIG. 1, in this embodiment the direction of travel is not controlled by moving the handle element 12 of the multifunction lever. To control the industrial truck, there is a first handle element 12 on the multifunction lever and a second handle element 14 on the control lever 13 for the direction of travel of the industrial truck. The second handle element 14, starting from the illustrated neutral position, can be pivoted forward or back around the transverse axis y of the industrial truck. As a result of which, the direction of travel of the industrial truck can be switched to forward or reverse, respectively. The location of the additional control lever 13 immediately next to the first handle element 12 (multifunction lever) is ergonomically advantageous because it makes it possible to switch back and forth from one lever to the other.

It will be readily appreciated by those skilled in the art that modifications may be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

1. A multifunction lever for an industrial truck, comprising:
a handle element movably mounted on a base body; and
a sensor configured to detect and measure movements of the handle element relative to the base body,
wherein the handle element is movable relative to the base body in rotation around at least two coordinate axes and in translation in a direction of at least one coordinate axis.

2. The multifunction lever as claimed in claim 1, wherein the handle element is movable relative to the base body in rotation around three coordinate axes.

3. The multifunction lever as claimed in claim 1, wherein the handle element is movable relative to the base body in translation in directions of at least two coordinate axes.

4. The multifunction lever as claimed in claim 1, wherein the coordinate axes belong to a system of rectangular coordinates.

5. The multifunction lever as claimed in claim 1, wherein the base body is part of an armrest of the industrial truck.

6. The multifunction lever as claimed in claim 1, wherein the sensor is configured so that when the handle element is moved in translation in a direction of a vertical coordinate axis, a signal for vertical movement of a load-carrying means is generated.

7. The multifunction lever as claimed in claim 1, wherein the sensor is configured so that when the handle element is moved in translation in a direction of a coordinate axis that runs in a transverse direction of the industrial truck, a signal for lateral displacement of a load-carrying means is generated.

8. The multifunction lever as claimed in claim 1, wherein the sensor is configured so that when the handle element is moved in rotation around a coordinate axis that runs in a transverse direction of the industrial truck, a signal for tilting of a load-carrying means is generated.

9. The multifunction lever as claimed in claim 1, wherein the sensor is configured so that when the handle element is moved in rotation around a coordinate axis that runs in a longitudinal direction of the industrial truck, a signal is generated for a rotation of load-carrying means around an axis that is oriented substantially in a longitudinal direction of the industrial truck.

10. The multifunction lever as claimed in claim 1, wherein the sensor is configured so that when the handle element is moved in rotation around a vertical coordinate axis, a signal for opening or closing of a load-holding device is generated.

11. The multifunction lever as claimed in claim 1, wherein the sensor is configured so that when the handle element is moved in translation in a direction of a coordinate axis that runs in a longitudinal direction of the industrial truck, a signal for determination of the direction of travel of the industrial truck is generated.

12. A control unit for an industrial truck, comprising:
a multifunction lever including a first handle element movably mounted on a base body; and
an additional control lever located next to the multifunction lever, the additional control lever including a second handle element movable in a longitudinal direction of the industrial truck and associated with a signal transmitted to specify a direction of travel of the industrial truck.

13. The control unit as claimed in claim 12, wherein the second handle element is movable exclusively in the longitudinal direction of the industrial truck.

14. The control unit as claimed in claim 12, wherein the second handle element is located immediately next to the first handle element, so that both handle elements can be operated by an operator without changing arm position.

15. The multifunction lever as claimed in claim 3, wherein the handle element is movable relative to the base body in translation in directions of three coordinate axes.

16. The control unit as claimed in claim 12, wherein the first handle element is movable relative to the base body in rotation around three coordinates.

17. The control unit as claimed in claim 12, wherein the first handle element is movable relative to the base body in translation in directions of at least two coordinate axes.

18. The control unit as claimed in claim 12, wherein the first and second elements are part of an armrest of the industrial truck.
